(19) United States
(12) Patent Application Publication
(10) Pub. No.: US 2015/0262110 A1
(43) Pub. Date: Sep. 17, 2015

(54) SYSTEMS AND METHODS FOR UTILITY CREW FORECASTING

(71) Applicant: General Electric Company, Schenectady, NY (US)

(72) Inventors: Andre Craig Henriques, Mableton, GA (US); Ramon Juan San Andres, Duluth, GA (US); Vernon Meadows, Lilburn, GA (US); Marc Karl Losee, Woodstock, GA (US)

(73) Assignee: General Electric Company, Schenectady, NY (US)

(21) Appl. No.: 14/204,856

(22) Filed: Mar. 11, 2014

(51) Int. Cl. G06Q 10/06

(52) U.S. Cl. CPC G06Q 10/063112; G06Q 10/0631; G06Q 10/06315; G06Q 10/06312

(57) ABSTRACT

A system includes a utility analytics system having a memory configured to store an event forecaster. The utility analytics system also includes a processor communicatively coupled to the memory. The processor is configured to receive or access data related to weather conditions, vegetation conditions, and historical events along the power grid, and the processor is also configured to execute instructions of the event forecaster to identify one or more potential events in the power grid based at least in part on the data related to weather conditions, vegetation conditions, and historical events along the power grid.

### BACKGROUND

The subject matter disclosed herein relates generally to utility management systems, and more specifically, to systems and methods of forecasting power outage events and managing utility assets.

An electrical network (e.g., a power grid) may include a number of electrical components (e.g., power sources, transmission or distribution lines, transformers, capacitors, switches, and similar components) that work together to produce, convert, and transmit electrical power throughout the electrical network. Power outages or other incidents at locations along the electrical network may be caused by various factors such as vegetation conditions around the electrical components or severe weather, for example. Generally, utility assets, such as equipment and personnel, are sent to repair electrical components at locations along the electrical network in response to power outages. However, allocation and dispatch of utility assets in response to power outages results in long power outage times, high costs, and/or inefficient use of utility assets.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a system includes a utility analytics system having a memory configured to store an event forecaster. The utility analytics system also includes a processor communicatively coupled to the memory. The processor is configured to receive or access data related to weather conditions, vegetation conditions, and historical events along the power grid, and the processor is also configured to execute instructions of the event forecaster to identify one or more potential events in the power grid based at least in part on the data related to weather conditions, vegetation conditions, and historical events along the power grid.

In one embodiment, a non-transitory computer-readable medium having computer executable code stored thereon is provided. The code includes instructions to access stored weather data, vegetation data, and historical event data. The code also includes instructions to identify locations of one or more potential events in a power grid based on weather data, vegetation data, or historical events. The code also includes instructions to determine a corrective response to the one or more potential events, wherein the corrective response comprises an allocation of utility assets.

In one embodiment, a method includes the steps of receiving or accessing, via a processor of a utility analytics system, weather condition data, vegetation data, and historical event data for a power grid. The method also includes determining, via the processor, locations of one or more potential events in the power grid based at least in part on the weather condition data, the vegetation data, and the historical event data. The method further includes determining, via the processor, an allocation of utility assets to correct to the one or more potential events.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of an energy generation, transmission, and distribution infrastructure system;

FIG. 2 is a block diagram of an embodiment of a utility analytics system included in the system of FIG. 1;

FIG. 3 illustrates potential events in a power grid over time, as determined by the utility analytics system of FIG. 2;

FIG. 4 illustrates an embodiment of a dispatch schedule that may be generated based on an appropriate allocation of utility assets, as determined by the utility analytics system of FIG. 2; and

FIG. 5 is a flowchart illustrating an embodiment of a process suitable for identifying potential events in an energy infrastructure system and determining an appropriate allocation of utility assets to address the potential events.

### DETAILED DESCRIPTION

One or more specific embodiments of the invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the invention, the articles “a,” “an,” “the,” and “said” are intended to mean that there are one or more of the elements. The terms “comprising,” “including,” and “having” are intended to be inclusive and mean that there may be additional elements other than the listed elements.

Utility service providers may wish to forecast (e.g., predict) potential events (e.g., incidents), such as power outages, and/or proactively manage allocation of utility assets based on the potential events. This may allow for efficient dispatch/usage of utility assets, such as equipment and/or personnel (e.g., crew or technicians). Accordingly, present embodiments relate to systems and methods for forecasting potential power outages or other events in the electrical network. Present embodiments also relate to systems and methods for determining an appropriate response to the potential events, such as proactively determining an appropriate allocation of utility assets to efficiently address the potential events, for example.

Particularly, a utility analytics system may include an event forecaster (e.g., an event forecaster module or component) having instructions that allow a processor to forecast potential events based on various data. For example, the event forecaster may include instructions that allow the processor to forecast potential events based on weather data, vegetation data, and/or historic (e.g., past) event data for the electrical network may be utilized to forecast potential events. In some embodiments, the utility analytics system may include a response generator (e.g., a response generator module or component) having instructions that allow a processor to determine an appropriate response to efficiently address the potential events. For example, the responder may include instructions that allow the processor to determine an appropriate allocation of utility assets in an anticipatory manner, such as an appropriate dispatch of equipment and/or personnel to locations of the potential events.

As discussed in more detail below, the utility analytics system may provide information indicative of the potential events and/or the appropriate allocation of utility assets on a display, and/or the utility analytics system may output data indicative of the potential events and/or the appropriate allocation of utility assets to another system for further processing, for example. As used herein, an event may generally refer to a power outage (e.g., an interruption of electric power service or other utility service delivered to consumers by a utility and/or other utility service provider) or to any incident in the electrical network, such as physical damage to components of the electrical network. It should be noted that the techniques described herein may not be limited to electric power utilities, but may also be extended to any utility, including gas utilities, water utilities, sewage removal, and the like. For example, the present embodiments may be applied to determine potential events and/or appropriate responses for gas and/or water utility service providers.

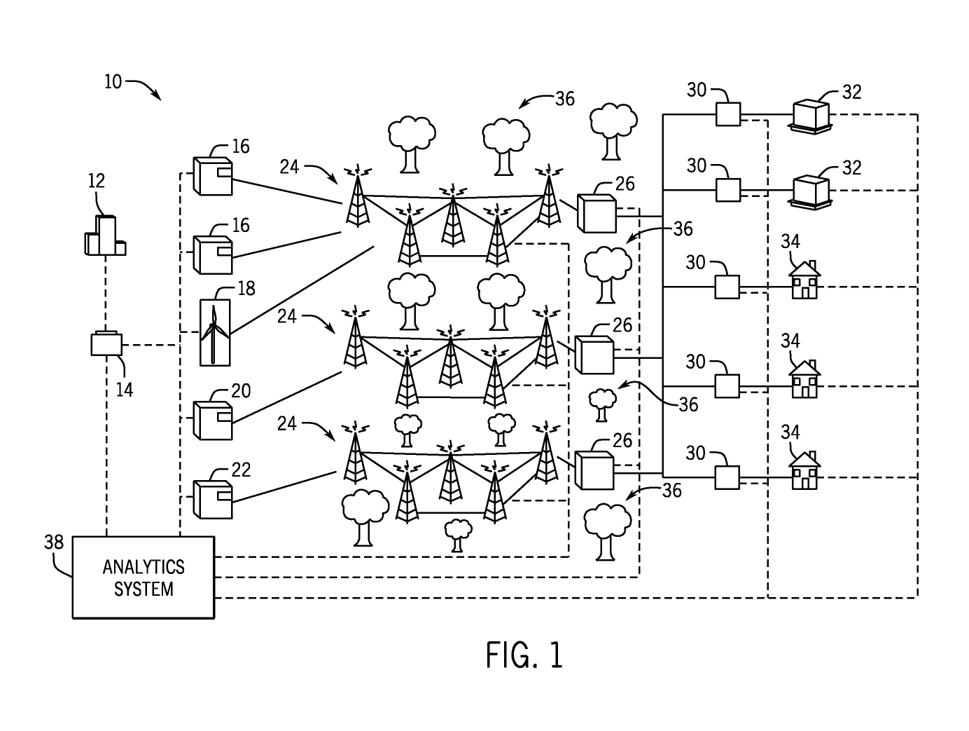

With the foregoing in mind, it may be useful to describe an embodiment of an electrical network, such as an example power grid system 10 illustrated in FIG. 1. As depicted, the power grid system 10 may include one or more utilities 12 (e.g., utility providers). The utility 12 may provide for oversight operations of the power grid system 10. For example, utility control centers 14 may monitor and direct power produced by one or more power generation stations 16 and alternative power generation stations 18. The power generation stations 16 may include conventional power generation stations, such as power generation stations using gas, coal, biomass, and other carbonaceous products for fuel. The alternative power generation stations 18 may include power generation stations using solar power, wind power, hydroelectric power, geothermal power, and other alternative sources of power (e.g., renewable energy) to produce electricity. Other infrastructure components may include a water power producing plant 20 and geothermal power producing plant 22. For example, water power producing plants 20 may provide for hydroelectric power generation, and geothermal power producing plants 22 may provide for geothermal power generation.

The power generated by the power generation stations 16, 18, 20, and 22 may be transmitted via a power transmission grid 24. The power transmission grid 24 may cover a broad geographic region or regions, such as one or more municipalities, states, or countries. The power transmission grid 24 may also be a single phase alternating current (AC) system, but most generally may be a three-phase AC current system. As depicted, the power transmission grid 24 may include a series of towers to support a series of overhead electrical conductors in various configurations. For example, extreme high voltage (EHV) conductors may be arranged in a three conductor bundle, having a conductor for each of three phases. The power transmission grid 24 may support nominal system voltages in the ranges of 110 kilovolts (kV) to 765 kilovolts (kV) or more. In the depicted embodiment, the power transmission grid 24 may be electrically coupled to a power distribution substation 26. The power distribution substation 26 may include transformers to transform the voltage of the incoming power from a transmission voltage (e.g., 765 kV, 500 kV, 345 kV, or 138 kV) to primary (e.g., 13.8 kV or 4154V) and secondary (e.g., 480V, 240V, or 120V) distribution voltages. For example, industrial electric power consumers (e.g., production plants) may use a primary distribution voltage of 13.8 kV, while power delivered to commercial and residential consumers may be in the secondary distribution voltage range of 120V to 480V. Furthermore, the power distribution substation 26 may include a system of distribution service feeders (e.g., three-phase and/or single-phase electric power mains connected to the secondary side of the substation to deliver to consumers of a particular geographical region) and a series of laterals (e.g., single-phase service subfeeders delivering power to consumers of a particular neighborhood, subdivision, or other sub region).

As again depicted in FIG. 1, the power transmission grid 24 and the power distribution substation 26 may be part of the power grid system 10. Accordingly, the power transmission grid 24 and the power distribution substation 26 may include various digital and automated technologies to control power electronic equipment such as generators, switches, circuit breakers, reclosers, and so forth. The power transmission grid 24 and the power distribution substation 26 may also include various communications, monitoring, and recording devices such as, for example, programmable logic controllers (PLCs), intelligent electronic devices (IEDs), digital fault recorders (DFRs), digital protective relays (DPRs), and so forth. In certain embodiments, voltage and current real-time data (e.g., electrical fault events) may be recorded at the power transmission grid 24 and communicated to the utility control center 14.

In certain embodiments, a meter 30 may be an Advanced Metering Infrastructure (AMI) meter used to collect, measure, and analyze electric power usage and/or generation. For example, electric utilities may report to consumers their usage and/or generation per kilowatt-hour (kWh) for billing and/or crediting purposes. The meter 30 may be electrically and communicatively coupled to one or more of the components of the system 10, including the power transmission grids 24, the power distribution substation 26, and a commercial and/or industrial consumer 32 and residential consumer 34. Additionally, the meter 30 may allow two-way communication between commercial sites 32, residences 34, and the utility control center 14, providing for a link between consumer behavior and electric power usage and/or generation. As noted above, electric power may also be generated by the consumers (e.g., commercial consumers 32, residential consumers 34). For example, the consumers 32, 34 may interconnect a distributed generation (DG) resource (e.g., solar panels or wind turbines) to generate and deliver power to the power distribution substation 26.

The power transmission grid 24 and/or the power distribution substation 26 may be affected by weather conditions (e.g., wind, snow, or the like). For example, severe storms may interfere with, or create a disturbance (e.g., electrical fault) on the power transmission grid 24 and/or the power distribution substation 26, and by extension, may cause an interruption of the electric power service delivered to the consumers 32 and 34. Additionally, the power transmission grid 24 and/or the power distribution substation 26 may be surrounded by or constructed near vegetation 36, such as trees, shrubs, bushes, undergrowth, or other plant life. The vegetation 36 may interfere with the power transmission grid 24 and/or the power distribution substation 26, and therefore, may cause interruption of the electric power service.

In some cases, weather conditions and vegetation 36 in combination may cause interruptions in power service. For example, certain weather conditions may cause the vegetation 36 to blow into, or otherwise fall upon one or more transmission lines of the power transmission grid 24 and/or service feeders or service subfeeders of the power distribution substation 26. This may create an electrical fault (line-to-ground fault, double line-to-ground fault, and so forth) on the power transmission grid 24 and/or the power distribution substation 26. Such electrical faults may lead to both temporary and/or permanent power outages experienced by the consumers 32 and 34.

In response to power outages, the utility 12 may dispatch assets, such as equipment and personnel, to restore power. However, assets are typically allocated and dispatched to certain locations on the power transmission grid 24 and/or to the power distribution substation 26 in a reactive manner, after power outages are identified. Such methods of restoring power may result in long power outage times and/or inefficient management or use of utility assets (e.g., capital investment, man-hours, and so forth).

Accordingly, it may be useful to provide a utility analytics system 38 to be used, for example, by an operator of the utility control center 14 for data collection and/or analysis to forecast potential events, such as power outages, and/or to determine an appropriate response to the potential events. In some embodiments, the response may include an anticipatory determination of an appropriate allocation of assets needed to address (e.g., correct) the potential events, as discussed in more detail below.

In certain embodiments, the utility analytics system 38 may be any hardware system, software system, or a combination thereof, suitable for receiving, accessing, transferring, storing, analyzing, deriving, and/or modeling energy delivery data, business data, weather data, vegetation data, traffic data, prior event data (e.g., historical or prior power outage data), and/or utility asset data, such as experience levels of utility personnel and equipment available to the utility 12. For example, as will be discussed in further detail below, the utility analytics system 38 may include an Advanced Analytics and Visualization Framework (AAVF) and may include various modules or subsystems (e.g., software systems implemented as computer executable instructions stored in a non-transitory machine readable medium such as memory, a hard disk drive, or other short term and/or long term storage) that may be used to determine business and/or operational related parameters, such as potential event forecasting and/or asset allocation. Accordingly, the utility analytics system 38 may receive inputs from a variety of sources, including the power generation stations 16, 18, 20, and 22, the power transmission grid 24, the power distribution substation 26, the meters 30, as well as various external sources, and provide information to, for example, an operator of the utility control center 14.

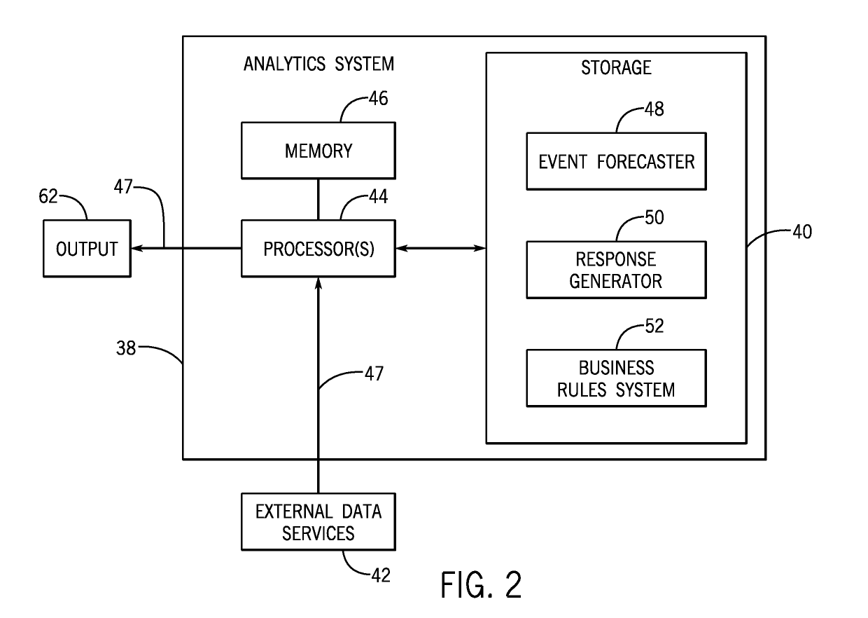

FIG. 2 is a block diagram of an embodiment of the utility analytics system 38. As illustrated, the utility analytics system 38 may include long term storage 40, one or more processors 44, a memory 46, input/output (I/O) ports (e.g., one or more network interfaces 47), an operating system, software applications, and so forth, useful in implementing the techniques described herein. Particularly, the utility analytics system 38 may include code or instructions stored in a non-transitory machine-readable medium (e.g., the memory 46 and/or the storage 40) and executed, for example, by the one or more processors 44 that may be included in the utility analytics system 38. The one or more processors 44 may include one or more processing devices, and the memory circuitry may include one or more tangible, non-transitory, machine-readable media collectively storing instructions executable by the one or more processors 44 to perform the methods and actions described herein. Such machine-readable media can be any available media that can be accessed by the one or more processors 44 or by any general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by the processor or by any general purpose or special purpose computer or other machine with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a processor, such as the one or more processors 41, or any general purpose computer, special purpose computer, or special purpose processing machines to perform a certain function or group of functions. As discussed below, the one or more processors 44 may execute instructions or code contained on the machine-readable or computer-readable storage medium and generate one or more outputs, as discussed in more detail below.

Additionally, the utility analytics system 38 may include a network interface 47, which may allow communication within the system 10 via a personal area network (PAN) (e.g., NFC), a local area network (LAN) (e.g., Wi-Fi), a wide area network (WAN) (e.g., 3G or LTE), a physical connection (e.g., an Ethernet connection, power line communication (PLC)), and/or the like. In certain embodiments, the utility analytics system 38 may receive and/or store data useful for forecasting potential events, such as power outages, and/or determining an appropriate response to the potential events, as discussed in more detail below.

As depicted, the utility analytics system 38 may receive data from one or more external data services 42 communicatively coupled to the one or more processors 44 of the utility analytics system 38. The one or more processors 44 may be configured to receive, access, transfer, store, analyze, derive, and/or model data received from the one or more external data services 42. For example, the one or more processors 44 may store the received data in the storage 40, or in any other suitable storage device, to allow subsequent access to the data. The external data services 42 may provide energy and business-related data, which in some embodiments, may be derived and/or calculated based on data received from the power transmission grid 24, the power distribution substation 26, the meters 30, and so forth. The external data services 42 may additionally or alternatively provide weather data, vegetation data, traffic data, utility asset data, and/or any other suitable data, as discussed in more detail below.

By way of example, in certain embodiments, the external data services 42 include an Outage Management System (OMS) that may detect current power outage or interruption events such as, for example, temporary and/or permanent electrical faults (e.g., line-to-ground faults, double line-to ground faults, and so forth) on the power transmission grid 24 and/or the power distribution substation 26 possibly caused by weather conditions or the vegetation 36, for example. In certain embodiments, the utility analytics system 38 may store and/or use the data received via the OMS related to electrical faults to predict future potential events, such as power outages, as discussed in more detail below. In some embodiments, the weather conditions and/or the vegetation 36 at the location and the time of the electrical fault may be stored and used to predict future potential events.

In some embodiments, the external data services 42 include a Geographic Information System (GIS) that may be used to provide physical location information (e.g., location information regarding specific distribution service feeders) of the power transmission grids 24 and the power distribution substation 26 to the utility analytics system 38. The physical location information may be used, for example, to identify particular locations of potential events and/or to create a map of the various components and/or the potential events on a display presented to, for example, an operator of the utility control center 14. In some embodiments, the GIS may be used to provide physical location information of the utility assets, such as current physical locations of personnel and equipment, for example.

In some embodiments, the external data services 42 include a Customer Information System (CIS) to obtain customer information, including customer characteristics (e.g., a residential home, a commercial office, a hospital, and so forth), billing information, energy usage information, load profiles, the number of outages and the duration of each outage experienced by the consumers 32, 34, and the like. In other embodiments, the external data services 42 may include a Meter Data Management (MDM) system useful in management of large quantities of energy data that may be received, for example, from the meters 30. Such data may primarily include usage data, events data (e.g., power service interruptions), alarms, and/or alerts that are received from the meter 30 via AMI or Automatic Meter Reading (AMR) systems. Yet still, the utility analytics system 38 may receive external data from a Meter Data Repository (MDR) which calculates the amount of electricity used by the consumers 32, 34, for example, during peak, near-peak, and off-peak hours, which may be a further indicator of an impact of potential events. In some embodiments, the utility analytics system 38 may consider and/or determine power outage duration (e.g., the period of time the consumers 32, 34 may experience the power outage) and the number of consumers 32, 34 affected by the power outage. Such information may be received by the utility analytics system 38 and/or derived by the utility analytics system 38 based on data received via the OMS, DMS, GIS, CIS, MDM, MDR, and AMI systems and/or data (e.g., real-time) received from the transmission grid 24, the distribution substation and grid 26, the meters 30, and so forth. Additionally, such information may be utilized to determine the appropriate response to the potential events. For example, the appropriate response may be a response that results in a shortest power outage duration, affects a lowest number of customers, or the like.

In some embodiments, the utility analytics system 38 may receive data from the external data services 42, for example, that may be useful for forecasting potential events and/or proactively allocating utility assets. For example, the external data services 42 may include any suitable source of weather data (e.g., prior, current, and/or forecasted weather data), such as one or more weather prediction systems (e.g., Global Forecast System, Doppler radars, and the like). By way of another example, the external data services 42 may include any suitable source of vegetation data (e.g., vegetation density and/or species), such as satellites (e.g., meteorological satellites useful in providing Normalized Difference Vegetation Index (NDVI) data) and/or LIDAR and/or LADAR systems. Additionally or alternatively, vegetation data may be provided to the utility analytics system 38 based on vegetation 36 that is observed and reported, such as via an input by the operator of the utility 12, for example. By way of a further example, the external data services 42 may include any suitable source of traffic data (e.g., real-time traffic data, predicted traffic delays, or traffic trends), such as one or more traffic monitoring systems (e.g., local departments of transportation and the like), and so forth. The data from the external data services 42 may be provided to the utility analytics system 38 and utilized, analyzed, transferred, stored, or the like, as set forth above.

The external data services 42 may also include an Asset Information System (AIS). In some embodiments, information related to equipment and/or personnel available to the utility may be provided via any suitable source. For example, experience levels, technical expertise, and/or other information related to the personnel may be provided. By way of example, technical features (e.g., hoists or carrying capacity) or repair/maintenance/out-of-service schedules (e.g., oil changes) of the equipment may be provided. The times that various equipment and/or personnel are available for dispatch, as well as the location (e.g., the current location and/or future location) of the equipment and/or personnel, may be provided. As will be further appreciated, the data received via the OMS, DMS, GIS, CIS, MDM, MDR, AMI, AIS, weather prediction systems, satellites, traffic systems, and/or other external data services 42 maybe stored in storage 40 (e.g., in one or more databases). The data may be accessed and/or used in steps executed by the one or more processors 44 in accordance with instructions provided by various subsystems or modules of the utility analytics system 38, such as an event forecaster 48 (e.g., an event forecasting system, or event forecasting component, or an event forecasting module) and/or a response generator 50 (e.g., a response system, a response component, a response module, a crew forecaster, or an asset allocation generator), for example.

In certain embodiments, the event forecaster 48 may be a software system and/or a combination of software and hardware that may be used to determine or to forecast potential events, such as power outages, at certain locations of the power transmission grid 24 and the power distribution substation 26. In certain embodiments, the event forecaster 48 may include instructions accessible and executable by the one or more processors 44 of the utility analytics system 38, and the instructions may allow the one or more processors 44 to predict potential events based on current and/or future weather conditions, vegetation data, and/or prior event data (e.g., power outage data) provided by any of a variety of suitable external data services 42, such as the OMS, the GIS, weather systems, and/or satellites, for example. The instructions of the event forecaster 48 may include instructions to allow the one or more processors 44 to process the data received via the external data services 42 using any of a variety of probabilistic techniques, such as statistical methods (e.g., linear regression, non-linear regression, ridge regression, data mining) and/or artificial intelligence models (e.g., expert systems, fuzzy logic, support vector machines [SVMs], logic reasoning systems) to predict potential events and/or to identify the location of potential events, such as potential power outages caused by weather conditions, vegetation, and/or equipment failures, and so forth.

Information related to the identified potential events may be stored locally in any suitable storage device (e.g., the storage 40 or the memory 46). In certain embodiments, the utility analytics system 38 may be configured to provide information related to the potential events to an output 62 (e.g., via one or more network interfaces 47). The output 62 may include a display integrated or associated with the utility analytics system 38, a remote or separate monitor or system, a mobile device, or the like. In some embodiments, the output 62 may be a separate system where the information related to the potential events may be further processed or analyzed, for example.

In some embodiments, the instructions provided by the event forecaster 48 may allow the one or more processors 44 to determine a likelihood (e.g., probability) of a potential event occurring at a certain location based on various data. For example, weather data, vegetation data, and/or prior event data may be utilized in various algorithms by the one or more processors 44 to determine the likelihood of a power outage occurring at a certain location. If the likelihood exceeds a predetermined threshold, the one or more processors 44 may identify (e.g., mark or record) the location as a site of a potential event. For example, a predetermined threshold of 50% may be stored in the storage 40 of the utility analytics system 38 and accessed by the one or more processors 44. In such cases, if it is determined that there is greater than a 50% chance of a power outage occurring at the location, the one or more processors 44 may identify the location as a site of a potential event. It should be understood that any suitable predetermined threshold may be used, such as 10%, 20%, 30%, 40%, 50%, 60%, 70%, 80%, 90%, or the like. In certain embodiments, the instructions provided by the event forecaster 48 may allow the one or more processors 44 to rank certain locations based on the likelihood of an event occurring at each location, which may facilitate allocation of the utility assets to the location(s) most likely to experience a power outage, for example.

By way of non-limiting example, with respect to a first location in the power grid, the vegetation data may indicate a high density of vegetation at the first location, the weather data may indicate that a storm center is expected to pass over the first location or that a high amount of snow, rain, and/or wind is expected at the first location, and/or the prior power outage data may indicate that the first location historically experienced power outages in 90% of severe storms. However, with respect to a second location, the vegetation data may indicate a low density of vegetation at the second location, the weather data may indicate that only weak portions of the storm are expected to pass over the second location and/or that a low amount of snow, rain, and/or wind is expected at the second location, and/or the prior power outage data may indicate that the second location historically experienced power outages in less than 50% of severe storms. The instructions of the event forecaster 48 may allow the one or more processors 44 to predict a likelihood of an event at each location and/or to rank the locations based on the likelihood of an event occurring at each location. By way of example, the utility analytics system 38 may determine, using the one or more processors 44, that there is a greater likelihood of an event at the first location relative to the second location. In certain embodiments, such information or ranking may be stored locally and/or provided to the output 62, for example. In some embodiments, such information or ranking may be taken into account during the proactive allocation of utility assets, as discussed in more detail below.

Similar to the event forecaster 48, the response generator 50 may be a software system and/or a combination of software and hardware, which may be used to derive and/or to determine an appropriate response to the potential event(s). For example, the appropriate response to the forecasted potential events may include proactively determining an appropriate allocation of utility assets needed to efficiently correct the potential events. The response generator 50 may include instructions accessible and executable by the one or more processors 44 of the utility analytics system 38, and the instructions may allow the one or more processors 44 to determine the appropriate allocation of utility assets based on information (e.g., location, time, likelihood, ranking, and so forth) related to potential events as determined by the utility analytics system 38 based on instructions provided by the event forecaster 48, as discussed above. Additionally, in some embodiments, the instructions included in the response generator 50 may allow the one or more processors 44 to determine the appropriate allocation of assets based at least in part on weather data from the weather prediction systems and/or current, past, and/or future predicted traffic data. In some embodiments, the instructions included in the response generator 50 may be allow the one or more processors 44 to determine the appropriate allocation of assets based at least in part on data related to equipment and/or personnel available to the utility, such as the experience level, technical expertise, and/or location of the available personnel and/or the location of available equipment, or the like. For example, correcting events at feeders may require personnel with different experience than correcting events at substations,

Thus, in certain embodiments, the instructions included in the response generator 50 may be executed the one or more processors 44 to determine the appropriate allocation of assets based on one or more of information related to the forecasted potential events, weather data, traffic data, current and future locations of the assets (e.g., the proximity of the assets to the potential events), experience levels of the personnel, technical expertise of the personnel, features of the equipment, for example. In certain embodiments, the one or more processors 44 may receive and/or access data from any of a variety of sources, such the storage 40 of the utility analytics system 38. For example, the one or more processors 44 may access information related to the potential events from the storage 40. The instructions of the response generator 50 may include instructions to allow the one or more processors 44 to process the data received via the external data services 42 and/or information related to the potential events using any of a variety of probabilistic techniques, such as statistical methods (e.g., linear regression, non-linear regression, ridge regression, data mining) and/or artificial intelligence models (e.g., expert systems, fuzzy logic, support vector machines [SVMs], logic reasoning systems) to determine an allocation of utility assets to correct the potential events in an anticipatory manner.

Information related to the appropriate response (e.g., the utility asset allocation) may be stored locally in any suitable storage device (e.g., the storage 40 or the memory 46). In certain embodiments, the utility analytics system 38 may be configured to provide information related to the asset allocation via any suitable output, such as the output 62 (e.g., via one or more network interfaces 47). As noted above, the output 62 may include a display integrated or associated with the utility analytics system 38, a remote or separate monitor or system, a mobile device, or the like. In some embodiments, the output 62 may be a separate system where the information related to the asset allocation may be further processed or analyzed, for example.

By way of non-limiting example, after one or more potential events are identified, the one or more processors 44 of the utility analytics system 38 may access instructions from the response generator 50. The one or more processors 44 may access various data, such as information related to the available personnel (e.g., crews), from the storage 40, for example. In some embodiments, the one or more processors 44 may execute the instructions to determine an appropriate asset allocation, which may include an allocation or assignment of the personnel closest to the location of the potential event (e.g., driving distance). However, in certain embodiments, the one or more processors 44 may be instructed to consider additional data, such as personnel expertise and/or technical skills. For example, the one or more processors 44 may access and us current or expected traffic, as well as resulting time delays, that the personnel might encounter on the way to the location of the potential event. The one or more processors 44 may access and use weather data, such as severe storms, ice, snowfall, rainfall or the like in proximity to the personnel or that the personnel might encounter on the way to the location of the potential event. Thus, for example, the personnel physically closest to the potential event location may not be allocated to the potential event if traffic delays and/or severe weather are predicted to cause delays or to otherwise interfere with the personnel's ability to reach the potential event location. Through such techniques, the one or more processors 44 execute the instructions provided by the response generator 50 to determine an appropriate allocation of utility assets to reduce power outage time and/or facilitate efficient use of utility assets.

In certain embodiments, the one or more processors 44 may determine the response according to certain criteria or predetermined rules (e.g., one or more business rules or response rules) generated by a business rules system 52 that may be included in the utility analytics system 38, such as in the storage 40 or the memory 46. The business rules system 52 may be any system (e.g., software system and/or software application) useful in generating one or more business rules including, for example, financial goals, company policies, legal regulations, and/or similar business operations data. For example, allocation of utility assets may be based at least in part on criteria generated by the business rules system 52, such as limiting power outage time, limiting crew mileage traveled, limiting a number of crews dispatched, limiting costs associated with correcting the potential events, or any other suitable business rules or goals. Such criteria or rules may be established by the utility 12 and/or input into the utility analytics system 38 by an operator of the utility 12, for example. The utility 12 may also alter or update the criteria or rules based on current goals or preferences, for example. Thus, while the utility 12 has established that the goal is limited power outage time, the one or more processors 44 may be instructed to determine a first allocation of assets to achieve a lowest power outage time while addressing the potential events, and while the utility has established that the goal is limited costs, the one or more processors 44 may be instructed to determine a second, different allocation of assets to achieve a lowest cost while addressing the potential events.

Although the event forecaster 48 and the response generator 50 are illustrated as modules having instructions accessible and executable by the one or more processors 44 of the utility analytics system 38, it should be understood that in some embodiments the event forecaster 48 and/or the response generator 50 may each include memory and processors. Thus, in some embodiments, the event forecaster 48 and the response generator 50 may be configured to receive and/or store data, such as data from the external data services 42 and/or to execute instructions. In some such embodiments, the event forecaster 48 and the response generator 50 may interface with each other to share information and/or data and/or may be configured to output information via the output 62, for example. It should be understood that any hardware and/or software configuration suitable for identifying potential events and determining the appropriate response using the techniques set forth herein may be utilized.

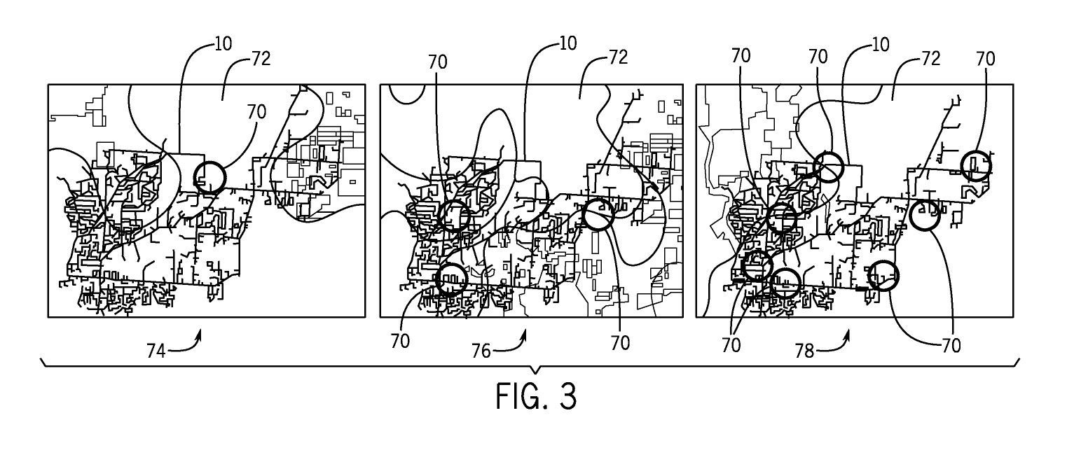

FIG. 3 illustrates potential events at certain locations of the power grid 10 over time, as may be determined by the one or more processors 44 of the utility analytics system 38. Indicators 70 represent locations of the potential events. A weather system 72 may move over the power grid 10. As the weather system 72 moves over the power grid 10, one potential event (e.g., as shown by indicator 70) may be identified at a first time 74. The number and distribution of potential events may change as the weather system 64 moves over the power grid 10. Thus, in the example shown, three potential events are identified at a second time 76, and seven potential events are identified at a third time 78. Thus, the utility analytics system 38 may identify locations of the potential events over time, using the one or more processors 44. The one or more processors 44 may then execute instructions provided by the response generator 50 to determine the appropriate allocation of assets based at least in part on the information related to the location and the time of the potential events, as discussed above.

In some embodiments, the utility analytics system 38 may be configured to provide information (e.g., location, time, likelihood, and so forth) related to the potential events and/or information related to the allocation of utility assets via the output 62, such as on a display, which may allow an operator of the utility control center 14 to view the information, for example. For example, in some embodiments, some or all of the information (e.g., power grid 10, indicators 70, or weather conditions 72) or images shown in FIG. 3 may be provided via the display. In certain embodiments, information related to the current or future location of the utility assets may additionally or alternatively be provided via the display. In certain embodiments, the utility analytics system 38 may be additionally or alternatively configured to output information related to the potential events and/or to the allocation of utility assets to a separate system, such as a separate computing system of the utility 12, for further processing and/or analysis, for example.

In some embodiments, the response generator 50 may provide instructions to allow the one or more processors 44 to generate a dispatch schedule (e.g., a strategic or anticipatory dispatch schedule) to facilitate allocation of the utility assets to correct the potential events. The dispatch schedule may generally provide information related to the personnel and/or the equipment needed at certain locations and/or at certain times. In some embodiments, the dispatch schedule may be provided via to the output 62, such as on a display that is coupled to the utility analytics system 38 and that is accessible by an operator of the utility control center 14. In some embodiments, the dispatch schedule may be output or provided to a separate system of the utility 12 for further analysis or processing, for example. In some embodiments, the dispatch schedule may be output to devices (e.g., mobile devices) accessible by the personnel to provide information regarding the personnel's anticipated schedule for a given time period as determined by the response system 50.

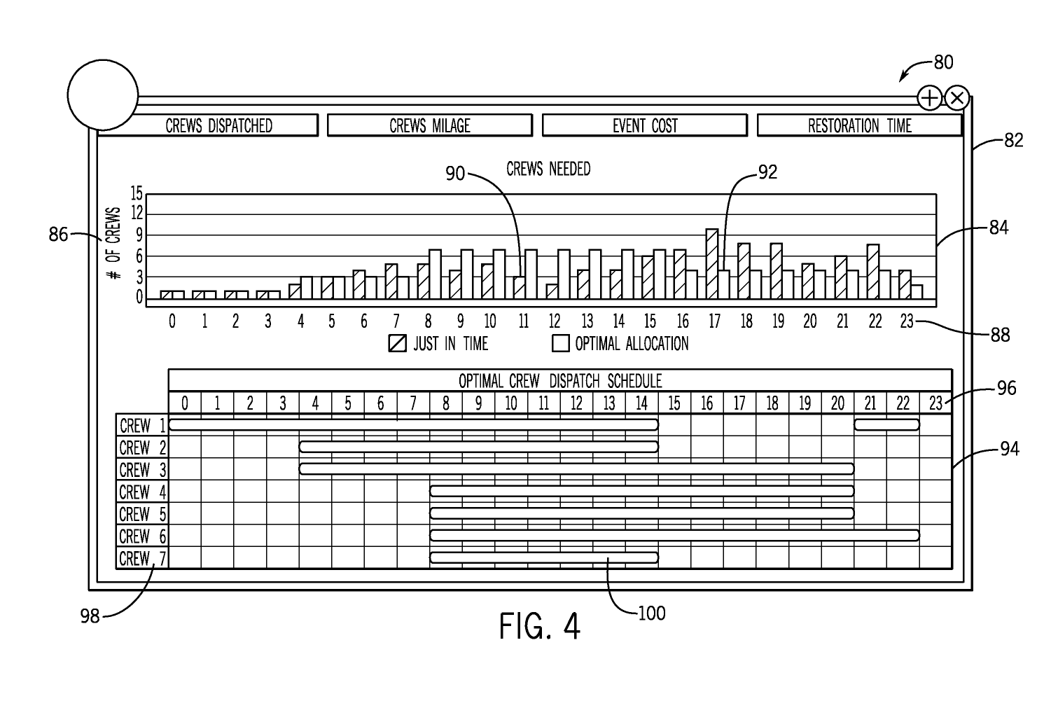

By way of non-limiting example, FIG. 4 illustrates one embodiment of a dispatch schedule 80 that may be provided to the output 62, although the dispatch schedule may be provided in any suitable form and may provide any suitable information. As shown, the output 62 includes a display 82 that provides a bar graph 84 indicative of an estimated number of crews needed 86 over time 88. The bar graph 84 may provide an estimated number of crews 90 needed for typical operation as well as an estimated number of crews 92 needed to correct potential events 82. As shown, the display 82 also provides a chart 94 that indicates working hours 86 for each personnel or crew 98. In the particular embodiment depicted, a location of each crew 98 at each time (e.g., working hours 96) may be provided or accessed by the operator or user by hovering over or clicking any each bar 100 at a particular time, for example. The above discussion is merely provided as an example to facilitate discussion of using the one or more processors 44 to execute instructions of the response generator 50 to proactively allocate utility assets to correct potential events and/or to generate a dispatch schedule, and it should be understood that the dispatch schedule and/or any information related to the allocation of assets may be provided in any suitable format.

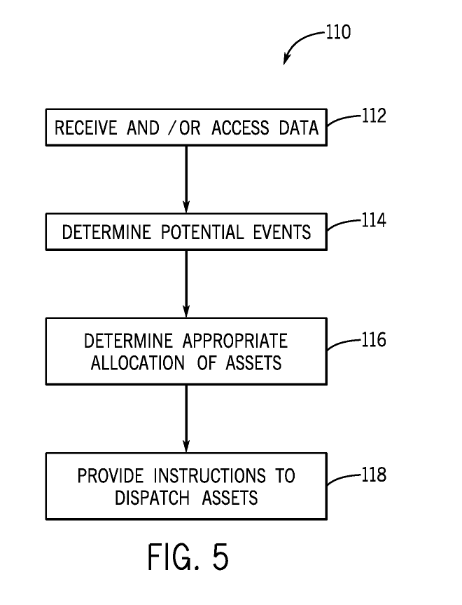

Turning now to FIG. 5, a flow diagram is presented, illustrating an embodiment of a process 110 useful in forecasting potential events and/or determining an appropriate response to potential events, by using, for example, the utility analytics system 38 included in the system 10 of in FIG. 1. The process 110 may include code or instructions stored in a non-transitory machine-readable medium (e.g., the storage 40) and executed, for example, by the one or more processors 44 included in the utility analytics system 38. The process 110 may begin with the utility analytics system 38 receiving and/or accessing (block 112) data. For example, as previously discussed, the utility analytics system 38 may receive, access, transfer, and/or store weather data, vegetation data, and/or historical power outage data via the external data services 42. Other data may also be received, analyzed, transferred, and/or stored including, for example, traffic data, utility asset data, energy utilization data, business-related data, regulatory data, and so on received, for example, via the external data services 42.

The process 110 may continue with the one or more processors 44 executing instructions of the event forecaster 48 to determine (block 114) potential events based on the data received and/or accessed. As set forth above, the instructions may allow the one or more processors 44 to predict potential events and/or to identify the location of potential events, such as potential power outages caused by weather conditions, vegetation, and/or equipment failures, and so forth using any of a variety of probabilistic techniques, such as statistical methods (e.g., linear regression, non-linear regression, ridge regression, data mining) and/or artificial intelligence models (e.g., expert systems, fuzzy logic, support vector machines [SVMs], logic reasoning systems). In some embodiments, information (e.g., location, time, or likelihood) related to the potential events may be stored locally for use in determining an appropriate response, for example. In certain embodiments, information related to the potential events may be provided to the output 62, such to a display and/or provided to another system for additional processing or analysis, for example.

The process 110 may continue with the one or more processors 44 executing instructions provided by the response generator 50 to proactively determine (block 116) an appropriate response to the potential events. In some embodiments, the one or more processors 44 may determine the appropriate allocation of assets based on one or more of information related to the forecasted potential events, weather data, traffic data, locations of the assets (e.g., the proximity of the assets to the potential events), experience levels of the personnel, technical expertise of the personnel, or features of the equipment, for example. The instructions may allow the one or more processors 44 to allocate utility assets to correct the potential events in an anticipatory manner using any of a variety of probabilistic techniques, such as statistical methods (e.g., linear regression, non-linear regression, ridge regression, data mining) and/or artificial intelligence models (e.g., expert systems, fuzzy logic, support vector machines [SVMs], logic reasoning systems). Furthermore, the determination of the appropriate allocation of assets may be governed at least in part by the business rules system 52, as discussed above with respect to FIG. 2. For example, the one or more processors 44 may determine the allocation of assets based on criteria generated by the business rules system 52, such as limiting power outage time, limiting crew mileage traveled, limiting a number of crews dispatched, limiting costs associated with correcting the potential events, or any other suitable business rules or goals. In certain embodiments, information related to the determined appropriate allocation of assets may be provided to the output 62, such as to a display and/or provided to another system for additional processing or analysis, for example.

In some cases, the process 110 may continue with the one or more processors 44 providing instructions or dispatching assets (block 118) according to the determined appropriate allocation of assets. For example, in some embodiments, the instructions of the response generator 50 may allow the one or more processors 44 to generate a dispatch schedule to inform utility personnel and/or operators of the utility 12 of times at which certain utility personnel should be at certain locations along the power grid system 10 to address the potential events. Thus, in certain embodiments, the utility analytics system 38 may provide instructions to dispatch or send the assets to the various locations to correct the potential events. Additionally, the response generator 50 may include instructions to allow the one or more processors 44 to periodically (e.g., at predetermined time intervals) and/or automatically update the allocation of assets, dispatch schedule, or instructions based on detected or confirmed current power outages or any changes in data, such as changes in weather data, traffic data, personnel availability, or the like.

Technical effects of the disclosed embodiments include systems and methods to forecast potential events, such as power outages, and to determine an appropriate response, such as an allocation of utility assets to address the potential events. Particularly, a utility analytics system may include an event forecasting system used to forecast potential events along power transmission grids and distribution substations service feeders, service subfeeders, and so forth. The utility analytics system may also include a response system used to determine the appropriate response to the potential events, such as by generating a dispatch schedule to allocate assets to address the potential events while reducing power outage time and/or providing efficient use of utility assets.

This written description uses examples to disclose the invention, including the best mode, and also to allow any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a utility analytics system, comprising:
a memory configured to store an event forecaster; and
a processor communicatively coupled to the memory and configured to:
receive or access data related to weather conditions, vegetation conditions, and historical events along the power grid; and
execute instructions of the event forecaster to identify one or more potential events in the power grid based at least in part on the data related to weather conditions, vegetation conditions, and historical events along the power grid.

2. The system of claim 1, wherein the memory is configured to store a response generator and the processor is configured to execute instructions of the response generator to determine an allocation of utility assets to correct the one or more potential events prior to occurrence of the one or more potential events.

3. The system of claim 2, wherein the processor is configured to allocate a number of personnel or equipment needed to correct each of the one or more potential events as the allocation of utility assets.

4. The system of claim 2, wherein the utility assets comprise personnel, and wherein the processor of the response system is configured to receive or to access data related to experience levels of the personnel and to execute instructions of the response generator to determine the allocation of the utility assets based at least in part on the experience levels.

5. The system of claim 2, wherein the processor is configured to receive or to access data related to traffic conditions and to execute instructions of the response generator to determine the allocation of the utility assets based at least in part on the traffic conditions.

6. The system of claim 2, wherein the processor is configured to execute instructions of the response generator to determine the allocation of the utility assets based at least in part on the weather conditions.

7. The system of claim 1, wherein the utility analytics system is configured to provide information related to the one or more potential events as an output to a remote system.

8. The system of claim 1, comprising a display configured to provide information related to the one or more potential events.

9. The system of claim 1, wherein the processor is configured to identify a time and a location of the one or more potential events.

10. A non-transitory computer-readable medium having computer executable code stored thereon, the code comprising instructions to:
access stored weather data, vegetation data, and historical event data;
identify locations of one or more potential events in a power grid based on the weather data, the vegetation data, or the historical event data; and
determine a corrective response to the one or more potential events, wherein the corrective response comprises an allocation of utility assets.

11. The non-transitory computer-readable medium of claim 10, wherein the code comprises instructions to determine the allocation of utility assets based at least in part on a location or a time of each of the one or more potential events.

12. The non-transitory computer-readable medium of claim 10, wherein the utility assets comprise personnel and the code comprises instructions to determine the allocation of the utility assets based at least in part on an experience level of the personnel.

13. The non-transitory computer-readable medium of claim 10, wherein the code comprises instructions to determine the allocation of the utility assets based at least in part on traffic data.

14. The non-transitory computer-readable medium of claim 10, wherein the code comprises instructions to generate a dispatch schedule representing the allocation of the utility assets to the locations of the one or more potential events over time.

15. The non-transitory computer-readable medium of claim 10, wherein the code comprises instructions to determine the allocation of the utility assets based on a lowest total power outage time or based on a lowest total cost to correct the one or more potential events.

16. A method, comprising:
receiving or accessing, via a processor of an utility analytics system, weather data, vegetation data, and historical event data for a power grid;
determining, via the processor, locations of one or more potential events in the power grid based at least in part on the weather condition data, the vegetation data, and the historical event data; and
determining, via the processor, an allocation of utility assets to correct to the one or more potential events.

17. The method of claim 16, comprising providing, via the processor, instructions to dispatch the utility assets to correct the one or more potential events.

18. The method of claim 17, comprising providing, via the processor, information indicative of the one or more potential events or information indicative of the allocation of utility assets on a display.

19. The method of claim 17, comprising receiving or accessing, via the processor, traffic data, and determining, via the processor, the allocation of the utility assets based at least in part on the traffic data.

20. The method of claim 16, comprising receiving or accessing, via the processor, data related to a current location of the utility assets and determining, via the processor, the allocation of the utility assets to correct the potential events based at least in part on the current location of the utility assets.
